(19) United States
(12) Patent Application Publication
(10) Pub. No.: US 2007/0267589 A1
(43) Pub. Date: Nov. 22, 2007

(54) One-way valve

(76) Inventor: Mark Downing, Palatine, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/708,192

(22) Filed: Feb. 20, 2007

Related U.S. Application Data
(60) Provisional application No. 60/801,822, filed on May 19, 2006.

(51) Int. Cl. F16K 31/44

(52) U.S. Cl. 251/213

(57) ABSTRACT

A valve that may be used in many applications, including applications requiring a one-way diaphragm valve. Embodiments of the invention include a cap which may be manually rotated and configured to maintain engagement with the valve body. The cap contains a groove suitable for an o-ring which maintains a seal between the valve body and the cap. The bottom of the valve is configured with a plurality of openings which allow fluid to be passed through them and out through the cap when pressure is applied to the bottom of the valve to deflect a diaphragm. The valve prevents fluid flow when the cap is manually rotated to a closed position.

### CROSS REFERENCE TO RELATED APPLICATIONS

This Non-Provisional Application claims benefit to U.S. Provisional Application Ser. No. 60/801,822 filed May 19, 2006.

### FIELD OF THE INVENTION

The present invention relates generally to valves, and more particularly to a one-way valve.

### BACKGROUND OF THE INVENTION

It is known that valves are used in various applications to perform various functions. Specifically one-way diaphragm valves are used in a multitude of applications. For example, diaphragm valves are used on personal cargo bags and inflatable devices which are designed to remain water and air tight during use. Most personal cargo wet-bags do not typically have a valve, but rather redundant sealing points, such as zippers, which fold over each other to create a treacherous path for water to get in. This type of bag is not usually submerged underwater for long periods of time. Various standard valves are found on most inflatable devices, where a person has to squeeze or otherwise deform (e.g., poke a nozzle through) the valve to get air inside.

There are also valves without a manual shut-off. Having a manual shut-off valve is desirable for applications where the user wishes to manually lock the valve so that if the bag is squeezed, air will not exhale out of the bag. Other valve types are used in SCUBA dry suits, which employ a rotating cap to control a spring that allows air to escape.

### SUMMARY OF THE INVENTION

The present invention is directed to a valve that may be used in many applications. In one embodiment, the valve according to the present invention is installed on the outside of a personal cargo bag that is designed to remain water and air tight during use. The valve will allow the user to squeeze the bag and let air out to minimize space and then auiomatically seal, preventing air from getting back in when the squeezing is stopped. This function is performed by a rubber diaphragm, which allows air to pass though the valve in only one direction. A cap on the valve has a slot which allows the cap to “lock” into place when the slot is engaged with a protrusion located on the inner wall of the valve body. In addition, the valve has an o-ring that creates a radial seal between the cap and the valve body when the cap is in a closed position.

The cap includes a member on the bottom surface which compresses the diaphragm down onto the sealing surface when the cap is in a closed position. The outer diameter of the cap is smaller than the inner diameter of the valve body. The wall of the valve body is recessed to allow air past the o-ring. In use, when the valve is open and the bag is squeezed, air passes through openings in the valve bottom and through the cap.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an isometric cross-sectional view of an embodiment of the valve according to the present invention.

FIG. 2 is an isometric exploded view of the valve of FIG. 1.

FIGS. 3a and 3b are isometric views of the top of two embodiments of the valve.

FIGS. 4a and 4b are cross-sectional side views of the valve assembly in the closed and open positions, respectively.

FIG. 5 is an isometric view of an embodiment of the valve body, diaphragm, and valve bottom.

FIG. 6 is a bottom view of the valve bottom and diaphragm.

FIG. 7 is a cross-sectional side view of an embodiment of the valve.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

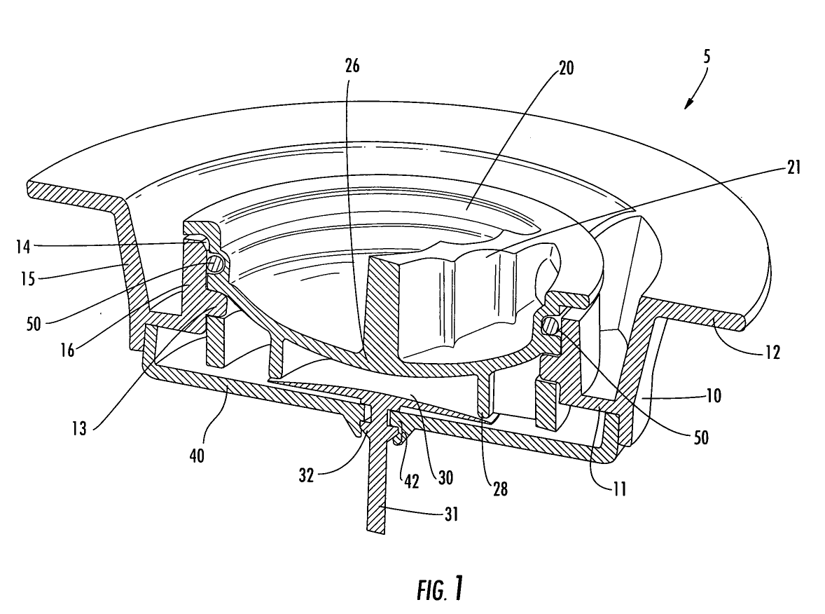

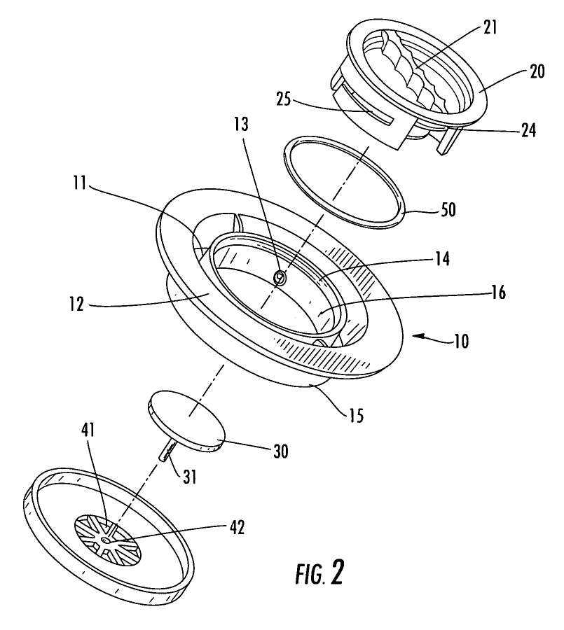

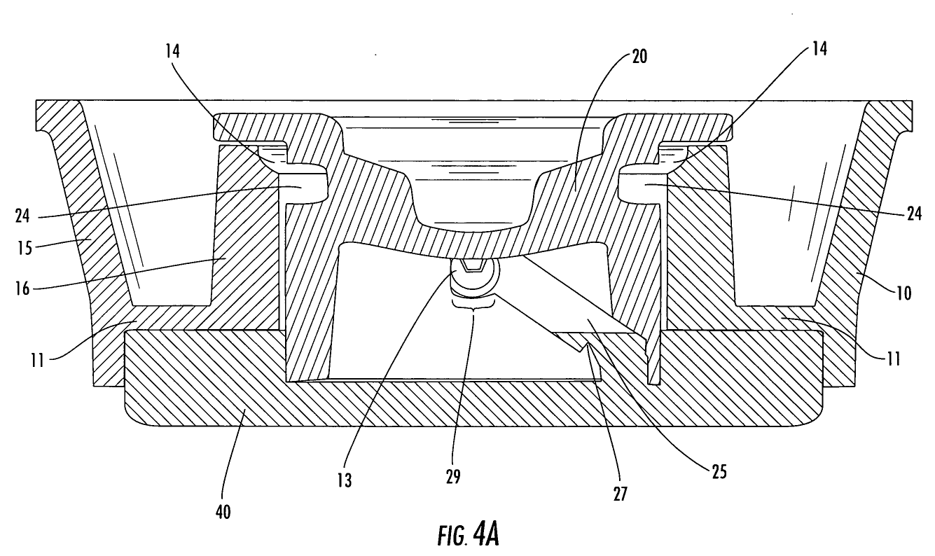

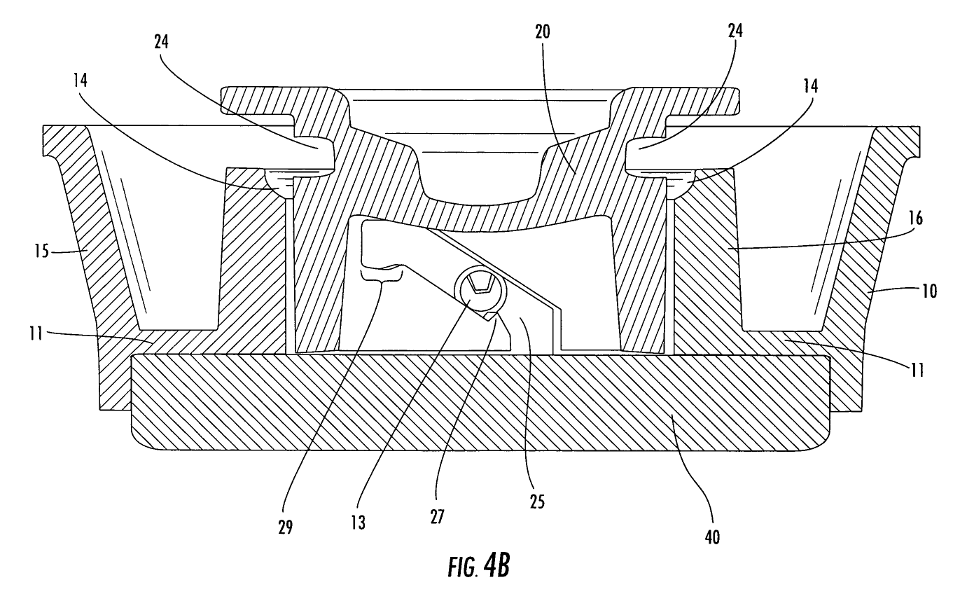

The present invention may be embodied in many forms. In one exemplary embodiment depicted in FIG. 1, in a cross-sectional view, the present invention is directed to a one-way diaphragm valve 5. FIG. 2 illustrates components of the valve 5 of FIG. 1. The valve 5 includes a valve body 10 that has an inner chamber 16 and an outer chamber 15, which are connected by a horizontal radial member 11, which is also illustrated in FIGS. 1, 4a, and 4b. The upper end of the inner chamber 16 defines a recess 14 to facilitate the passage of air out of the valve. A surface of the inner chamber 16 has a protrusion 13 extending from it, described in detail below. The valve body outer chamber 15 comprises a flat horizontal member 12, extending radially outward. The underside of the horizontal member 12 may be attached to another surface, such as a bag. The bag or other surface may be attached to the horizontal member 12 in any suitable manner. Such attachments may be made with an epoxy resin seal, glue, or a heat activated resin seal. Ultrasonic welding or a sewn on seal may also be employed. The valve body 10 may be made of any suitable materials. In one embodiment, the valve body 10 is made of plastic.

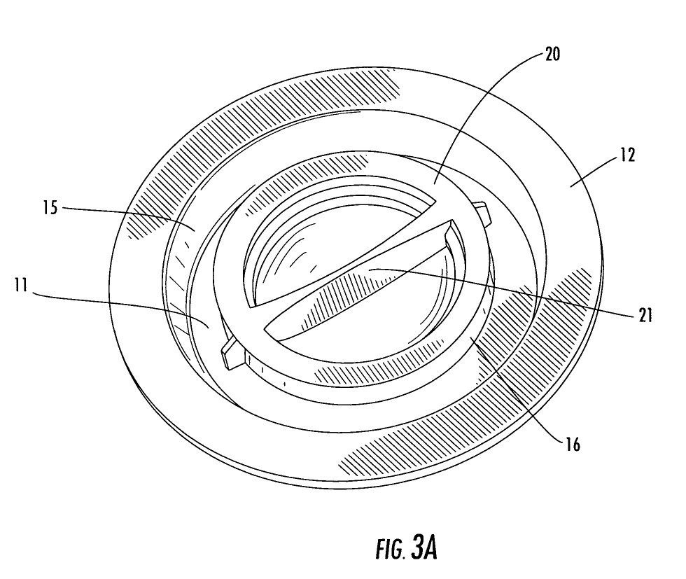

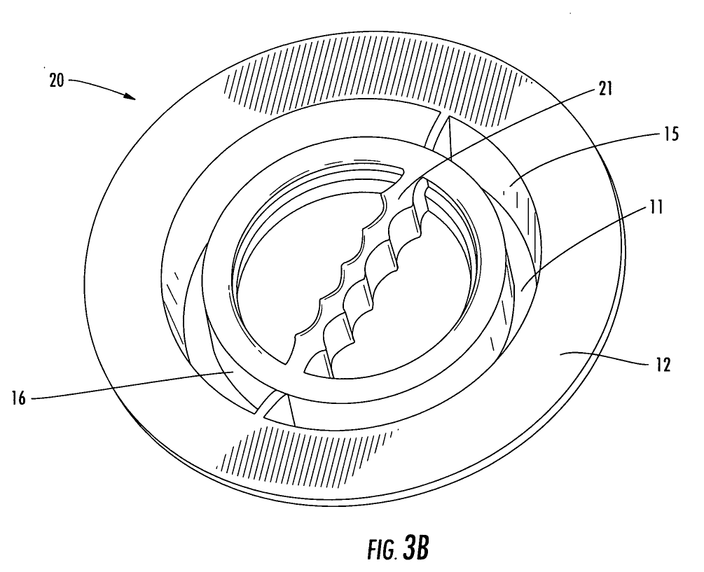

As shown in FIGS. 2, 3a and 3b, the valve 5 includes a cap 20 that has a grip member 21 extending generally perpendicular from the top surface. The grip member 21 is configured as a grip for manual rotation of the cap 20, between the open and closed positions. Embodiments of the grip member 21 are illustrated in FIGS. 3a and 3b. The grip member 21 may be flat on each side as shown in FIG. 3a, grooved to provide finger grips, as shown in FIG. 3b, or any other suitable configuration.

Referring to FIGS. 4a and 4b, the outer surface of the cap 20 comprises a groove 24. The groove 24 is configured to engage with an o-ring 50 (FIG. 1). As shown in FIGS. 2, 4a and 4b, the cap 20 outer surface also defines an angled slot 25 that is configured to engage with the valve body protrusion 13. When the cap 20 is rotated to the closed position, the protrusion 13 rests in the top portion 29 of the slot 25, which is configured in a complementary shape to the protrusion 13. An embodiment may comprise a round protrusion 13 and a rounded surface at the top portion 29 of the slot 25, for example. The bottom of the slot 25, as shown in FIG. 4b, comprises a protrusion 27 configured to maintain the protrusion 13 within the slot 25, and is configured to keep the cap 20 in place within the valve body 10 when the cap is in an open position. The protrusion 27 may be triangular in shape, as illustrated in FIGS. 4a and 4b. In an alternative embodiment, a plurality of protrusions, such as numerous small barbs, may be used instead of a single protrusion at or near the bottom of the slot 25. Referring back to FIG. 1, when the o-ring 50 is engaged with the cap 20 and the cap 20 is in a closed position, the o-ring 50 maintains its position within the groove 24 of the cap 20 and the recess 14 of the valve body 10, providing a seal between the valve body 10 and the cap 20. The o-ring 50 may be made of any suitable elastomeric material.

The valve 5 includes a diaphragm 30. The diaphragm 30 is illustrated in FIGS. 1 and 2. In an embodiment, the diaphragm 30 comprises a substantially round member and a stem 31 extends generally perpendicular from the center of the diaphragm 30. On the stem 31, near the surface of the diaphragm 30, a conical member 32 may be disposed. The stem 31, conical member 32, and diaphragm 30 may be made of any suitable elastomeric material. For example, the diaphragm 30, conical member 32, or the stem 31 may be made of rubber.

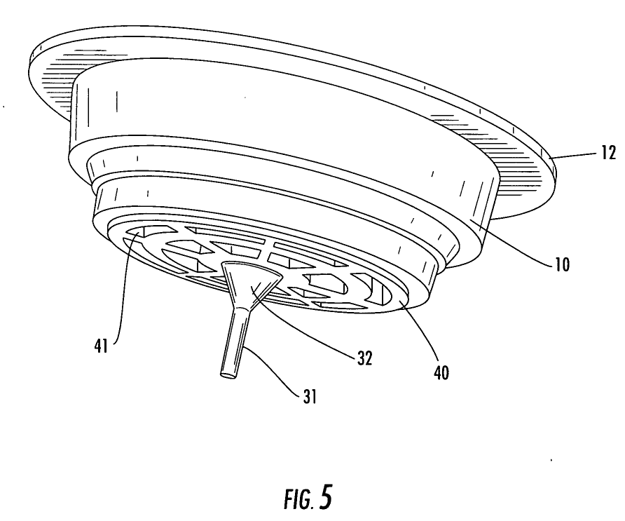

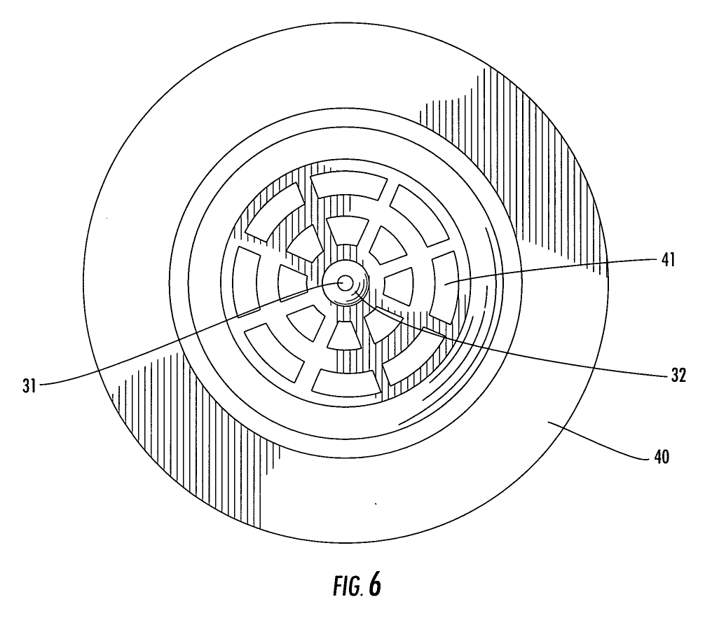

The valve 5 includes a valve bottom 40 that is illustrated in FIGS. 1, 2, 5, and 6. Referring specifically to FIG. 6, in an embodiment, the surface of the valve bottom 40 defines an opening 42. The opening 42 of the valve bottom 40 is configured to engage with the conical member 32 of the diaphragm stem 31 to secure the diaphragm 30 in place and to the valve bottom 40. The surface of the valve bottom 40 also defines a plurality of openings 41 configured to be the fluid passageway when the valve is in an open position. The plurality of openings 41 may be triangular in shape, or may be of any other suitable shape. The plurality of openings 41 may be arranged radially from the center opening 42, for example. The valve bottom 40 is configured to be attached to the valve body 10. This attachment may happen in any suitable manner, such as by ultrasonic welding.

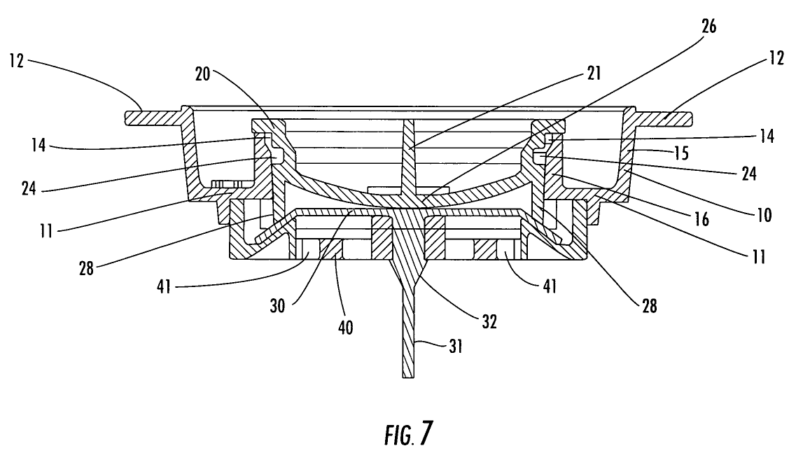

FIG. 7 illustrates the valve 5 with the cap 20 in a closed position. When the valve 5 is in a closed position, the bottom rounded surface 26 of the cap 20 is in communication with the diaphragm 30, which is held in position by the valve bottom 40. In this position, the diaphragm 30 will then be in communication with the plurality of openings 41 in the valve bottom 40. As shown in FIG. 1, when the cap is in the closed position, a radial protruding member 28 of the cap 20 contacts the edge of the diaphragm 30, preventing air flow in through the plurality of openings 41 on the valve bottom 40. When the cap 20 is in an open position, the protruding member 28 of the cap 20 moves away from the edge of the diaphragm 30 permitting fluid to pass by. Also, the o-ring 50 does not interfere with the valve body 10, thus permitting fluid to pass through the valve 5. Thus, in an open position, when pressure is applied to the valve by means such as squeezing the attached bag, fluid may pass through the plurality of openings 41, deflect the diaphragm and travel past the diaphragm and the valve body 10, exiting through the cap 20 via the gap between the cap 20 and the valve body 10.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A one-way valve comprising:
a valve body comprising:
an outer chamber,
an inner chamber having a protrusion disposed on an inner surface, and
a radial member connecting the inner and outer chambers,
a valve bottom attached to the valve body, the valve bottom comprising a surface that defines a plurality of openings,
a cap disposed in the inner chamber, the cap configured to be manually rotated between a closed position and an open position, and
a generally circular diaphragm disposed on the valve bottom and configured to deflect when the cap is in the open position and pressure is applied through the valve bottom openings, the diaphragm comprising a stem extending substantially perpendicular to the surface of the diaphragm, the stem mounted to the valve bottom.

2. The valve according to claim 1, wherein the outer chamber of the valve body comprises a substantially horizontal member extending radially outward.

3. The valve according to claim 1, wherein the inner chamber is angularly recessed to facilitate the outflow of fluid from the valve.

4. The valve according to claim 1, wherein the cap further comprises an elastomeric o-ring.

5. The valve according to claim 2, wherein the horizontal member of the valve body is configured to attach to a bag.

6. The valve according to claim 7, wherein the valve is attached to the bag by epoxy resin.

7. The valve according to claim 1, wherein the cap further comprises a grip member having flat sides, the grip member configured to facilitate the manual rotation of the cap.

8. The valve according to claim 1, wherein the cap further comprises a grip member having grooved sides, the grip member configured to facilitate the manual rotation of the cap.

9. The valve according to claim 1, further comprising a radial member disposed on the cap, wherein the radial member is configured to engage the diaphragm when the cap is in the closed position, the radial member comprising a diameter smaller than the diameter of the diaphragm.

10. A one-way valve comprising:
a valve body with an inner chamber and an outer chamber connected by a radial member, a surface of the inner chamber defining a protrusion, and the outer chamber comprising a substantially horizontal member extending radially outward,
an elastomeric diaphragm comprising a stem, the stem extending substantially perpendicular to a surface of the diaphragm and comprising a conical member,
a cap, comprising a top surface and a bottom surface, the top surface defining a protruding member configured to allow manual rotation of the cap between an open position and a closed position, the bottom surface defining a radially protruding member configured to engage with the diaphragm when the cap is in the closed position, the outer surface of the cap comprising a groove and an angular slot, wherein a top portion of the slot is configured to engage with the inner chamber protrusion when the cap is in the closed position and a bottom of the slot comprises a protrusion configured to maintain the engagement of the cap and the valve body,
an elastomeric o-ring configured to engage with the cap groove and provide a seal between the cap and the valve body when the cap is in the closed position, and
a valve bottom.

11. The valve according to claim 10, wherein the inner chamber defines an angular recess at a top surface to facilitate the outflow of fluid from the valve.

12. The valve according to claim 10, wherein the o-ring is rubber.

13. The valve according to claim 10, wherein valve bottom defines a plurality of openings and a center opening through which the diaphragm stem is disposed, the plurality of openings configured as a fluid inlet to deflect the diaphragm when pressure is applied against the valve bottom and the cap is in the open position

14. The valve according to claim 10, wherein the horizontal member of the valve body is configured to attach to a bag.

15. The valve according to claim 10, wherein the diameter of the radial member of the cap is smaller than the diaphragm, but larger than the diameter of the plurality of openings in the valve body.

16. A one-way valve comprising:
a valve body with an inner chamber and an outer chamber connected by a radial member, a surface of the inner chamber defining a protrusion, and the outer chamber comprising a substantially horizontal member extending radially outward,
an elastomeric diaphragm comprising a stem, the stem extending substantially perpendicular to a surface of the diaphragm and comprising a conical member,
a cap, comprising a top surface and a bottom surface, the top surface defining a protruding member configured to allow manual rotation of the cap between an open position and a closed position, the bottom surface defining a radially protruding member configured to engage with the diaphragm when the cap is in the closed position, the outer surface of the cap comprising a groove and an angular slot, wherein a top portion of the slot is configured to engage with the inner chamber protrusion when the cap is in the closed position and a bottom of the slot comprises a protrusion configured to maintain the engagement of the cap and the valve body,
an elastomeric o-ring configured to engage with the cap groove and provide a seal between the cap and the valve body when the cap is in the closed position, and
a valve bottom wherein the surface defines a plurality of openings and a center opening through which the diaphragm stein is disposed, the plurality of openings configured as a fluid inlet to deflect the diaphragm when pressure is applied against the valve bottom and the cap is in the open position.

17. The valve according to claim 16, wherein the inner chamber defines an angular recess at a top surface to facilitate the outflow of fluid from the valve.

18. The valve according to claim 16, wherein the o-ring is rubber.

19. The valve according to claim 16, wherein the horizontal member of the valve body is configured to attach to a bag.

20. The valve according to claim 16, wherein the diameter of the radial member of the cap is smaller than the diaphragm, but larger than the diameter of the plurality of openings in the valve body.
